(19) United States
(12) Patent Application Publication
(10) Pub. No.: US 2024/0361989 A1
(43) Pub. Date: Oct. 31, 2024

(54) SIMILARITY CONTRIBUTION DETECTING METHOD AND SIMILARITY CONTRIBUTION DETECTING SYSTEM

(71) Applicant: Mitsubishi Electric Corporation, Tokyo (JP)

(72) Inventor: Teng-Yok LEE, Tokyo (JP)

(73) Assignee: Mitsubishi Electric Corporation, Tokyo (JP)

(21) Appl. No.: 18/761,712

(22) Filed: Jul. 2, 2024

Related U.S. Application Data
(63) Continuation of application No. PCT/JP2022/005772, filed on Feb. 15, 2022.

(51) Int. Cl. G06F 7/78; G06N 3/0464

(52) U.S. Cl. CPC G06F 7/78; G06N 3/0464

(57) ABSTRACT

A method comprises calculating a first difference d between first and second input data a and b that are provided to a machine learning model that has a function f and outputs first and second results f(a) and f(b), where d=(elements d[1], . . . , d[n]), a=(elements a[1], . . . , a[n]), b=(elements b[1], . . . , b[n]), f(a)=(f(a)[1], . . . , f(a)[m]), f(b)=(f(b)[1], . . . , f(b)[m]); calculating transposed Jacobian matrices Ja^{T} and Jb^{T} by partially differentiating the function f with respect to the first and second input data a and b to yield Jacobian matrices Ja and Jb; calculating a first product of the matrix Ja^{T} and the result f(a), and a second product of the matrix Jb^{T} and the result f(b); calculating a second difference w between the products, where w=(elements w[1], . . . , w[n]); and judging that a larger product of an element d[j] of the first difference d and an element w[j] of the second difference w contributes more to a similarity between the results f(a) and f(b).

### CROSS REFERENCE TO RELATED APPLICATIONS

This application is a Continuation of PCT International Application No. PCT/JP2022/005772, filed on Feb. 15, 2022, all of which is hereby expressly incorporated by reference into the present application.

### TECHNICAL FIELD

The present disclosure relates to methods and systems for machine learning models that provide a plurality of output data in response to a plurality of input data, and more particularly to methods and systems for detecting in the plurality of input data, elements that contribute to a similarity among the plurality of output data.

### BACKGROUND ART

The data processing system for a machine learning model taught in Japanese Patent Laid-Open No. 2021-060763, which is one of the systems for machine learning model, has calculated the importance of elements in a plurality of input data to a plurality of output data. For the purpose of the calculation above, the data processing system utilizes a relationship among the above elements.

For example, on receipt of two image data a1 and a2 that are deemed to be similar to each other to humans, a conventional system, including the above data processing system, may conclude that the image data a1 and a2 are not similar to each other. In contrast, on receipt of two image data a1 and b1 that are deemed to be different from each other to humans, the above conventional system may conclude that the image data a1 and b1 are not different from each other.

However, it has not been possible to clarify or identify causes or origins why the above conventional system concludes inaccurately or misjudge as described above.

### CITATION LIST

### Patent Literature

[PTL 1]: JP 2021-060763 A

### SUMMARY OF THE INVENTION

To solve the above problem, an aspect of the present disclosure provides a method that comprises: calculating a first difference d between first input data a and second input data b that are provided to a machine learning model that has a function f and outputs a first result f(a) and a second result f(b) in response to the first input data a and the second input data b respectively, where d=(elements d[1], d[2], . . . , d[n]), a=(elements a[1], a[2], . . . , a[n]), b=(elements b[1], b[2], . . . , b[n]), f(a)=(f(a)[1], f(a)[2], . . . , f(a)[m]), f(b)=(f(b)[1], f(b)[2], . . . , f(b)[m]), and n and m are positive integers; calculating a transposed Jacobian matrix Ja^{T} and a transposed Jacobian matrix Jb^{T} by partially differentiating the function f with respect to the first input data a and the second input data b to yield a Jacobian matrix Ja and a Jacobian matrix Jb, and transposing the Jacobian matrix Ja and the Jacobian matrix Jb; calculating a first product of the transposed Jacobian matrix Ja^{T} and the result f(a), and a second product of the transposed Jacobian matrix Jb^{T} and the result f(b); calculating a second difference w between the first product and the second product, where w=(elements w[1], w[2], . . . , w[n]); and judging that a larger product of an element d[j] of the first difference d and an element w[j] of the second difference w contributes more to a similarity between the first result f(a) and the second result f(b), where j is a positive integer less than or equal to n.

Another aspect of the present disclosure provides the method that further comprises: in a case where the machine learning model is a neural network that includes a plurality of intermediate layers, permitting the function f to represent at least one of the plurality of intermediate layers; and judging that the function f contributes to the similarity less than a function g that represents a remainder of the plurality of intermediate layers prior to the at least one of the plurality of intermediate layers when a product of an element d[j] of the first difference d and an element w[j] of the second difference w, the first difference d and the second difference w being defined by using first intermediate data xa and second intermediate data xb fed into the function f, and a first result f (xa) and a second result f (xb) output by the function f, in lieu of using the first input data a and the second input data b, and the first result f(a) and the second result f(b).

Still another aspect of the present disclosure provides the method that further comprises in a case where the machine learning model is a convolutional neural network that includes a plurality of intermediate layers, permitting the function f to represent at least one of the plurality of intermediate layers; and specifying a first plurality of regions ra that respectively characterize a first plurality of maps ma that configure first intermediate data xa and a second plurality of regions rb that respectively characterize a second plurality of maps mb that configure second intermediate data xb, by filtering the first plurality of maps ma and the second plurality of maps mb respectively; the first intermediate data xa and the second intermediate data xb being output by a function g that represent a remainder of the plurality of intermediate layers prior to the at least one of the plurality of intermediate layers in response to the input data a and the second input data b respectively and fed into the function f and; connecting the first plurality of regions ra to the second plurality of regions rb for each of a plurality of channels that correspond to the first plurality of maps ma and the second plurality of maps mb.

Still another aspect of the present disclosure provides a system that comprises: a processor to execute a program; and a memory to store the program which, when executed by the processor, performs processes of, calculating a first difference d between first input data a and second input data b that are provided to a machine learning model that has a function f and outputs a first result f(a) and a second result f(b) in response to the first input data a and the second input data b respectively, where d=(elements d[1], d[2], . . . , d[n]), a=(elements a[1], a[2], . . . , a[n]), b=(elements b[1], b[2], . . . , b[n]), f(a)=(f(a)[1], f(a)[2], . . . , f(a)[m]), f(b)=(f(b)[1], f(b)[2], . . . , f(b)[m]), and n and m are positive integers; calculating a transposed Jacobian matrix Ja^{T} and a transposed Jacobian matrix Jb^{T} by partially differentiating the function f with respect to the first input data a and the second input data b to yield a Jacobian matrix Ja and a Jacobian matrix Jb, and transposing the Jacobian matrix Ja and the Jacobian matrix Jb; calculating a first product of the transposed Jacobian matrix Ja^{T} and the result f(a), and a second product of the transposed Jacobian matrix Jb^{T} and the result f(b); calculating a second difference w between the first product and the second product, where w=(elements w[1], w[2], . . . , w[n]); and judging that a larger product of an element d[j] of the first difference d and an element w[j] of the second difference w contributes more to a similarity between the first result f(a) and the second result f(b), where j is a positive integer less than or equal to n.

### BRIEF DESCRIPTION OF DRAWINGS

FIG. 1 is a block diagram showing a configuration of a feature extracting system FES.

FIG. 2 is a block diagram showing an operation of the feature extraction system FES.

FIG. 3 is a block diagram showing a configuration of the image data a and a configuration of Feature f(a).

FIG. 4 is a block diagram showing a configuration of the image data b and a configuration of Feature f(b).

FIG. 5 is a block diagram showing a Jacobian matrix Ja.

FIG. 6 is a block diagram showing a Jacobian matrix Jb.

FIG. 7 shows a difference d between the image data a and the image data b according to the first embodiment.

FIG. 8 shows a difference w between a product of the transposed Jacobian matrix Ja^{T} and the image data a, and a product of the transposed Jacobian matrix Jb^{T} and the image data b according to the first embodiment.

FIG. 9 is a block diagram showing a connection between the feature extracting system FES and a similarity contribution detecting system SCDS according to the first embodiment.

FIG. 10 is a block diagram showing a configuration of the similarity contribution detecting system SCDS according to the first embodiment from the constructional viewpoint.

FIG. 11 is a block diagram showing a configuration of the similarity contribution detecting system SCDS according to the first embodiment from the functional viewpoint.

FIG. 12 is a flowchart showing an operation of the similarity contribution detecting system SCDS according to the first embodiment.

FIG. 13 is a block diagram showing a configuration of a neural network system NNS.

FIG. 14 is a block diagram showing a configuration of the similarity contribution detecting system SCDS according to the second embodiment from the functional viewpoint.

FIG. 15 is a flowchart showing an operation of the similarity contribution detecting system SCDS according to the second embodiment.

FIG. 16 is a block diagram showing a configuration of a convolutional neural network system CNNS.

FIG. 17 is a block diagram showing a configuration of the similarity contribution detecting system SCDS according to the third embodiment from the functional viewpoint.

FIG. 18 is a flowchart showing an operation of the similarity contribution detecting system SCDS according to the third embodiment.

FIG. 19 is a block diagram showing an operation of the convolutional neural network system CNNS on the image data a.

FIG. 20 is a block diagram showing an operation of the convolutional neural network system CNNS on the image data b.

FIG. 21 shows a relationship among a plurality of maps ma and mb, a plurality of regions ra and rb, and a plurality of channel ch.

FIG. 22 shows connections between the plurality of regions ra and the plurality of regions rb.

### DESCRIPTION OF EMBODIMENTS

To describe the present disclosure further in detail, embodiments for carrying out the present disclosure will be described below with reference to the accompanying drawings.

### First Embodiment

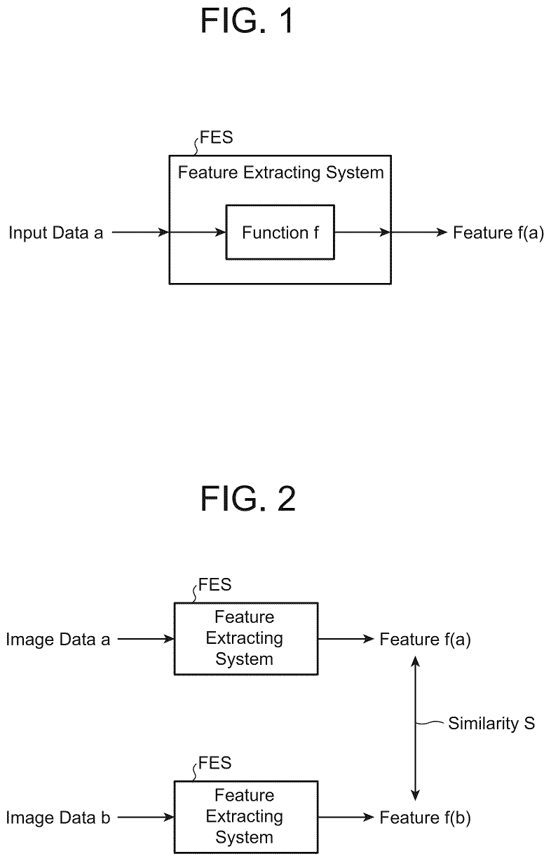

A similarity contribution detecting system according to a first embodiment of this disclosure will now be described with reference to FIGS. 1 to 12.

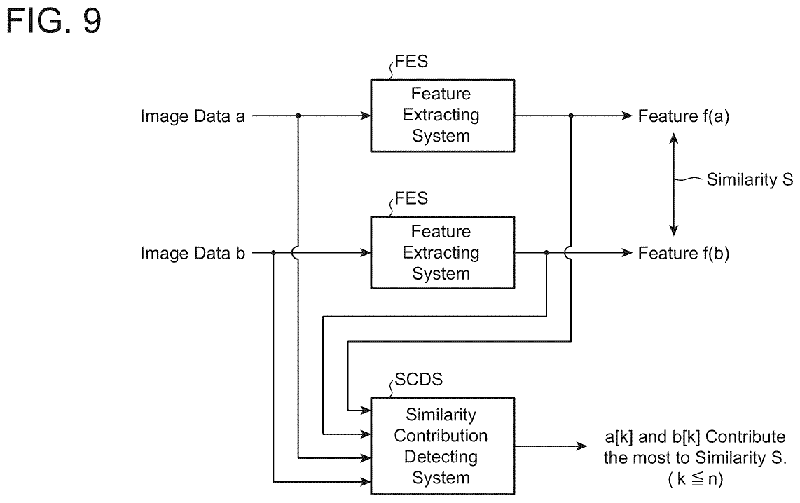

FIG. 1 is a block diagram showing a configuration of a feature extracting system FES. In the first embodiment, a similarity contribution detecting system SCDS (will later be described with reference to FIG. 9) according to the first embodiment analyzes both input data (more definitely, image data a and b as shown in FIG. 2) fed into the feature extracting system FES and output data (more definitely, Feature f(a) and Feature f(b) ditto) provided by the feature extracting system FES.

As shown in FIG. 1, the feature extracting system FES has a function f for extracting features from the input data.

FIG. 2 is a block diagram showing an operation of the feature extraction system FES. As shown in FIG. 2, the feature extracting system FES receives the image data a, extracts features from the received image data a, and outputs the extracted features as Feature f(a). Similar to the above, the feature extracting system FES receives the image data b, extracts features from the received image data b, and outputs the extracted features as Feature f(b). Herein, a similarity S between Feature f(a) and Feature f(b) denotes whether or not Feature f(a) and Feature f(b) are similar to each other, in other words, whether or not the image data a and the image data b are similar to each other.

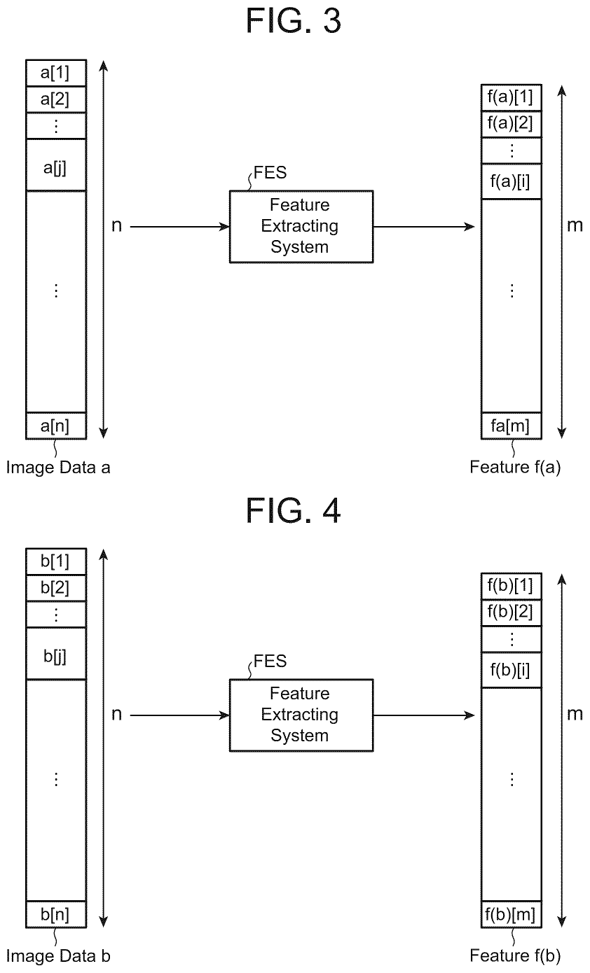

FIG. 3 is a block diagram showing a configuration of the image data a and a configuration of Feature f(a). FIG. 4 is a block diagram showing a configuration of the image data b and a configuration of Feature f(b).

As shown in FIG. 3, the image data a includes a set of elements a[1], a[2], a[3], . . . , and a[n] (n denotes a positive integer equal to or more than two). Similarly, as shown in FIG. 4, the image data b includes a set of elements b[1], b[2], b[3], . . . , and b[n]. Herein, an element a[j] represents one element among the former set of elements a[1], a[2], a[3], . . . , and a[n] while an element b[j] represents one element among the latter set of elements b[1], b[2], b[3], . . . , and b[n] (j denotes a positive integer equal to or less than n).

As shown in FIG. 3, Feature f(a) includes a set of elements f(a)[1], f(a)[2], . . . , and f(a)[m] (m denotes a positive integer equal to or more than two). Similarly, as shown in FIG. 4, Feature f(b) includes a set of elements f(b)[1], f(b)[2], . . . , and f(b)[m]. Herein, an element f(a)[i] represents one element among the former set of elements f(a)[1], f(a)[2], . . . , and f(a)[m] while an element f(b)[i] represents one element among the latter set of elements f(b)[1], f(b)[2], . . . , and f(b)[m] (i denotes a positive integer equal to or less than m).

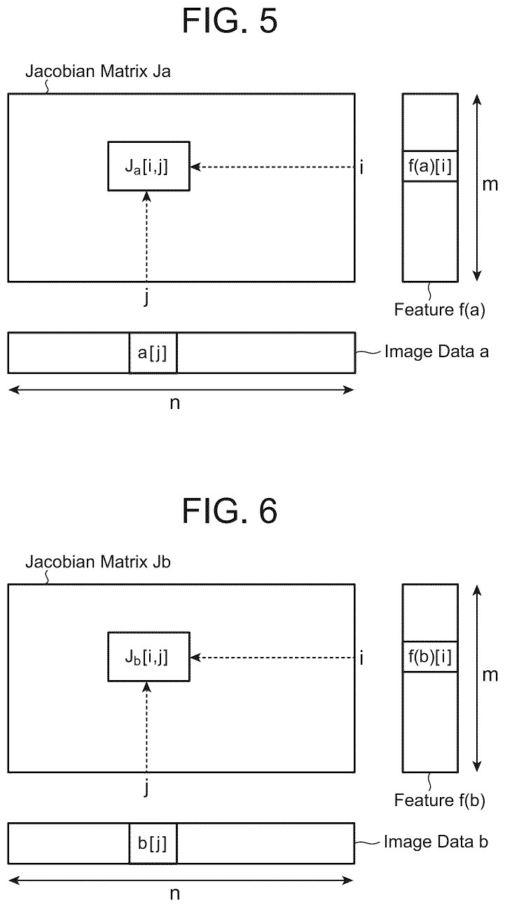

FIG. 5 is a block diagram showing a Jacobian matrix Ja. FIG. 6 is a block diagram showing a Jacobian matrix Jb. As shown in FIG. 5, the Jacobian matrix Ja includes a set of elements Ja[1,1], Ja[1,2], . . . , and Ja[m,n]. Similarly, as shown in FIG. 6, the Jacobian matrix Jb includes a set of elements Jb[1,1], Jb[1,2], . . . , and Jb[m,n]. Herein, an element Ja[i,j] represents one element among the former set of elements Ja[1,1], Ja[1,2], . . . , and Ja[m,n] while an element Jb[i,j] represents one element among the latter set of elements Jb[1,1], Jb[1,2], . . . , and Jb[m,n]. The element Ja[i,j] is given by partially differentiating the element f(a)[i] with respect to the element a[j]. Similarly, the element Jb[i,j] is given by partially differentiating the element f(b)[i] with respect to the element b[i].

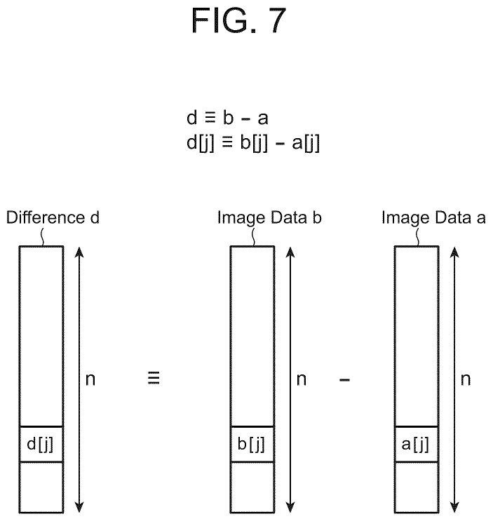

FIG. 7 shows a difference d between the image data a and the image data b according to the first embodiment. As shown in FIG. 7, the difference d is defined by subtracting the image data a (shown in FIG. 2) from the image data b (shown in FIG. 2) pursuant to Formula (1).

$$d ≡ b - a \qquad ( 1 )$$

Similar to both the image data a and the image data b shown in FIGS. 3 and 4, as shown in FIG. 7, the difference d includes a set of elements d[1], d[2], . . . , and d[m]. Herein, an element d[j] represents one among the set of elements d[1], d[2], . . . , and d[m]. The element d[j] is defined by subtracting the element a[j] (shown in FIG. 3) from the element b[j] pursuant to Formula (2).

$$d [ j ] ≡ b [ j ] - a [ j ] \qquad ( 2 )$$

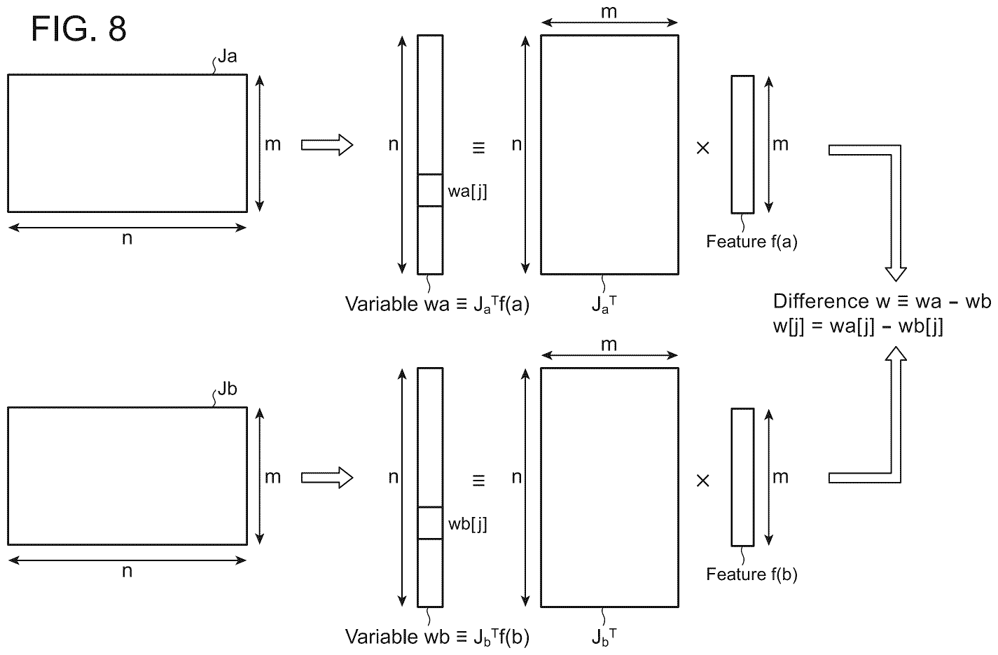

FIG. 8 shows a difference w between a product of a transposed Jacobian matrix Ja^{T} and the image data a, and a product of a transposed Jacobian matrix Jb^{T} and the image data b according to the first embodiment. Since the Jacobian matrix Ja includes a set of elements Ja[1,1], Ja[1,2], . . . , and Ja[m,n] as discussed above referring to FIG. 5, the transposed Jacobian matrix Ja^{T} includes a set of elements Ja[1,1], Ja[2,1], . . . , and Ja[n,m] as shown in FIG. 8. Herein, T denotes transposing of a matrix.

Similarly, since the Jacobian matrix Jb includes a set of elements Jb[1,1], Jb[1,2], . . . , and Jb[m,n] as discussed above referring to FIG. 6, the transposed Jacobian matrix Jb^{T} includes a set of elements Jb[1,1], Jb[2,1], . . . , and Jb[n,m] as shown in FIG. 8.

Assuming that a variable wa is defined by multiplying the transposed Jacobian matrix Ja^{T} (shown in FIG. 8) and Feature f(a) (shown in FIG. 2) together pursuant to Formula (3) while a variable wb is defined by multiplying the transposed Jacobian matrix Jb^{T} (shown in FIG. 8) and Feature f(b) (shown in FIG. 2) together pursuant to Formula (4), the difference w is given by subtracting the variable wb from the variable wa pursuant to Formula (5).

$$wa ≡ {{J}_{a}}^{T} f ( a ) \qquad ( 3 )$$

$$wb ≡ {{J}_{b}}^{T} f ( b ) \qquad ( 4 )$$

$$w ≡ wa - wb \qquad ( 5 )$$

Herein, an element w[j] represents one element among a set of elements w[1], w[2], . . . , and w[n]. The element w[j] is given by subtracting the element wb[j] (shown in FIG. 8) from the element wa[i] (shown in FIG. 8) pursuant to Formula (6).

$$w [ j ] ≡ wa [ j ] - wb [ j ] \qquad ( 6 )$$

In general, the result f (x) given by the function f on input data x is expanded pursuant to Formula (7) by applying the Taylor Expansion to the result f (x) on a reference point or a criterion point c adjacent to the input data x.

$$f ( x ) = f ( c ) + {J}_{c} ( x - c ) + … \qquad ( 7 )$$

Herein, similar to the Jacobian matrix Ja relevant to the input data a and the Jacobian matrix Jb relevant to the input data b discussed above referring to FIGS. 5 and 6, Jc denotes a Jacobian matrix relevant to the above criterion point c.

Substituting the image data b for the input data x and the image data a for the criterion point c leads to Formula (8).

$$f ( b ) = f ( a ) + {J}_{a} ( b - a ) + … \qquad ( 8 )$$

Transforming Formula (8) deduces Formula (9).

$$f ( b ) - f ( a ) \qquad ( 9 )$$

$$= {J}_{a} ( b - a ) = + …$$

$$∼ {J}_{a} ( b - a )$$

Formula (9) proves that the difference between Feature f(b) and Feature f(a) can be approximately expressed with a Jacobian matrix Ja (b-a)

Transforming the formula (9) gives the formula (10).

$$f ( b ) = f ( a ) + {J}_{a} ( b - a ) \qquad ( 10 )$$

Here, an inner product of Feature f(a) and Feature f(b) is calculated pursuant to Formula (11) to which Formula (10) is applied.

$$< f ( a ) , f ( b ) > \qquad ( 11 )$$

$$= < f ( a ) , f ( a ) + {J}_{a} ( b - a ) >$$

$$= {f ( a )}^{T} f ( a ) + {f ( a )}^{T} {J}_{a} ( b - a )$$

Applying Formulas (12) and (13) to Formula (11) under the Cosine Similarity Scheme derives Formula (14).

$${f ( a )}^{T} f ( a ) = 1 \qquad ( 12 )$$

$${f ( b )}^{T} f ( b ) = 1 \qquad ( 13 )$$

$${f ( a )}^{T} f ( a ) + {f ( a )}^{T} {J}_{a} ( b - a ) \qquad ( 14 )$$

$$= 1 + {f ( a )}^{T} {J}_{a} ( b - a )$$

$$≡ {f ( a )}^{T} {J}_{a} ( b - a )$$

$$= < {{J}_{a}}^{T} f ( a ) , b - a >$$

In summary, apparently from comparison between Formula (11) and Formula (14), the inner product of Feature f(a) and Feature f(b) can be expressed using Formula (15).

$$< f ( a ) , f ( b ) >= < {{J}_{a}}^{T} f ( a ) , b - a > \qquad ( 15 )$$

Formula (16) is given vice versa, more specifically, by substituting for the input data x the image data a in lieu of the image data b, and for the criterion point c the image data b in lieu of the image data a in Formula (7), and by following Formulas (8) to (14).

$$< f ( a ) , f ( b ) >= < {{J}_{b}}^{T} f ( b ) , a - b > \qquad ( 16 )$$

Formula (15) and Formula (16) bring the formula (17)

$$2 * < f ( a ) , f ( b ) > \qquad ( 17 )$$

$$= < {{J}_{a}}^{T} f ( a ) , b - a > + < {{J}_{b}}^{T} f ( b ) , a - b >$$

Transforming Formula (17) concludes with Formula (18).

$$2 * < f ( a ) , f ( b ) > \qquad ( 18 )$$

$$= < {{J}_{a}}^{T} f ( a ) , b - a > - < {{J}_{b}}^{T} f ( b ) , b - a >$$

$$= < {{J}_{a}}^{T} f ( a ) - {{J}_{b}}^{T} f ( b ) , b - a >$$

Formula (18) evidences that the inner product of Feature f(a) and Feature f(b) is represented by using only two terms: one is Ja^{T}f(a)−Jb^{T}f(b), and the other is b−a.

$$< {{J}_{a}}^{T} f ( a ) - {{J}_{b}}^{T} f ( b ) , b - a > \qquad ( 19 )$$

$$= w * d$$

$$= {Σ}_{j = 1 … n} w [ j ] d [ j ]$$

Expanding Formula (18) under condition of the above Formulas (1) to (6) deduces Formula (19), which details how to calculate the inner product of Feature f(a) and Feature f(b) by using the element w[j] (explained with reference to FIG. 8) and the element d[j] (explained with reference to FIG. 7).

In conclusion, the similarity contribution detecting system SCDS (shown in FIG. 9) according to the first embodiment will evaluate degree of contribution that the element a[j] and the element b[j] contribute to the similarity S (shown in FIG. 2) between Feature f(a) and Feature f(b) by using the inner product of Feature f(a) and Feature f(b), that is, the element w[j] and the element d[j].

FIG. 9 is a block diagram showing a connection between the feature extracting system FES and the similarity contribution detecting system SCDS according to the first embodiment. As shown in FIG. 9, the similarity contribution detecting system SCDS receives the image data a, the image data b, Feature f(a), and Feature f(b). The similarity contribution detecting system SCDS executes Formula (19), thereby answering, for example, that an element a[k] in the image data a and an element b[k] in the image data b contribute the most to the similarity S between Feature f(a) and Feature f(b), where k is less than or equal to n (discussed above referring to FIGS. 3 and 4.

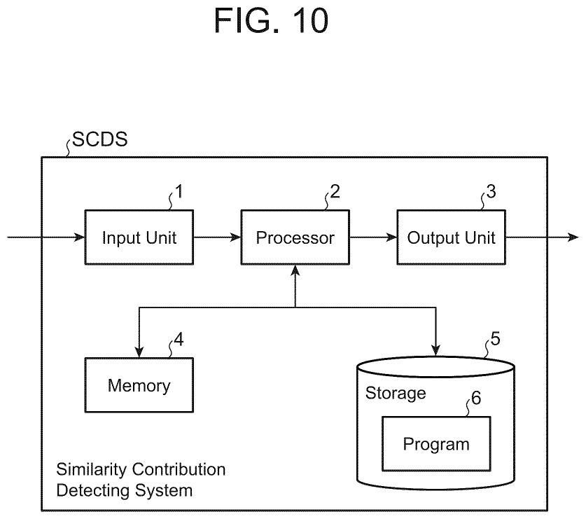

FIG. 10 is a block diagram showing a configuration of the similarity contribution detecting system SCDS according to the first embodiment from the constructional viewpoint. As shown in FIG. 10, from the constructional viewpoint, the similarity contribution detecting system SCDS includes an input unit 1, a processor 2, an output unit 3, a memory 4, and a storage 5. The storage 5 has a program 6 that defines the operation of the processer 2.

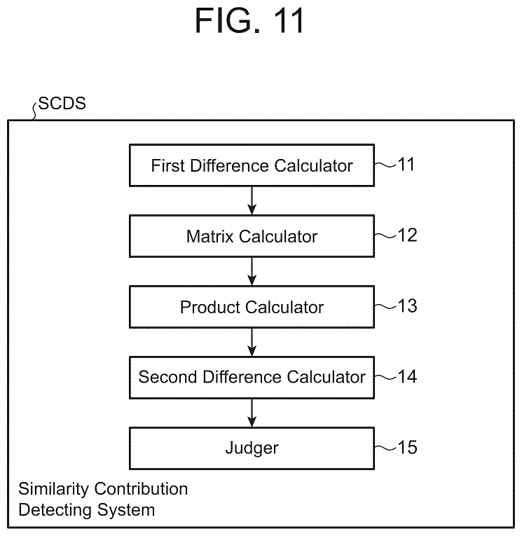

FIG. 11 is a block diagram showing a configuration of the similarity contribution detecting system SCDS according to the first embodiment from the functional viewpoint. As shown in FIG. 11, from the functional viewpoint, the similarity contribution detecting system SCDS includes a first difference calculator 11, a matrix calculator 12, a product calculator 13, a second difference calculator 14, and a judger 15.

With reference to FIGS. 10 and 11, the input unit 1 and the output unit 3 serve as a user interface for a user manipulating the similarity contribution detecting system SCDS; the processor 2 acts as each of the first difference calculator 11 to the judger 15 by executing in the memory 4 the program 6 stored in the storage 5.

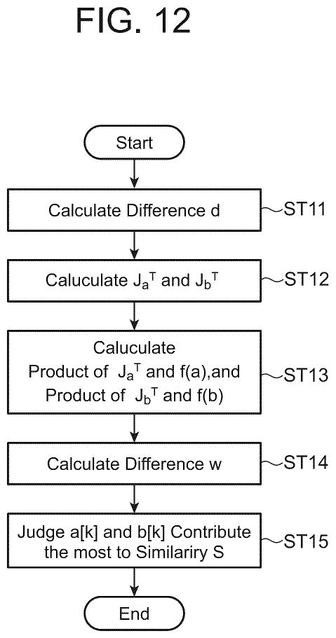

FIG. 12 is a flowchart showing an operation of the similarity contribution detecting system SCDS according to the first embodiment. At step ST11, the first difference calculator 11 calculates the difference d (shown in FIG. 7) by subtracting the image data a (shown in FIG. 7) from the image data b (shown in FIG. 7) pursuant to Formula (1). More specifically, the first difference calculator 11 calculates the elements d[j] (shown in FIG. 7) by subtracting the element a[j] (shown in FIG. 7) from the elements b[j] (shown in FIG. 7) pursuant to Formula (2).

At step ST12, the matrix calculator 12 calculates the transposed Jacobian matrix Ja^{T} (shown in FIG. 8) by partially differentiating the function f (shown in FIG. 1) of the feature extracting system FES based on the image data a to yield the Jacobian matrix Ja (shown in FIG. 5) and transposing the Jacobian matrix Ja. Similarly, the matrix calculator 12 calculates the transposed Jacobian matrix Jb™ (shown in FIG. 8) by partially differentiating the function f based on the image data b to yield the Jacobian matrix Jb (shown in FIG. 6) and transposing the Jacobian matrix Jb.

At step ST13, the product calculator 13 calculates a first product wa (equivalent to the variable wa discussed above referring to FIG. 8) of the transposed Jacobian matrix Ja^{T} and Feature f(a) pursuant to Formula (3). Similarly, the product calculator 13 calculates a second product wb (equivalent to the variable wb discussed above referring to FIG. 8) of the transposed Jacobian matrix Jb^{T} and Feature f(b) pursuant to Formula (4).

At step ST14, the second difference calculator 14 calculates a second difference w (equivalent to the difference w discussed above referring to FIG. 8) between the first product wa and the second product wb pursuant to Formula (5). More specifically, the second difference calculator 14 yields the element w[j] between element wa[j] and the element wb[j] pursuant to Formula (6).

At step ST15, the judger 15 judges that a larger product of an element d[i] and an element w[j] among a product of an element d[1] and an element w[1] to a product of an element d[n] and an element w[n] (implicitly shown in FIGS. 7 and 8) contributes more to the similarity S between Feature f(a) and Feature f(b) (shown in FIGS. 2 and 9). Among the elements a[1] to a[n] and the elements b[1] to b[n], the judger 15 judges, for example, that an element a[k] and an element b[k] contribute the most to the similarity S as described above referring to FIG. 9.

As described above, the similarity contribution detecting system SCDS according to the first embodiment analyzes or evaluates each of the product of the element d[1] and the element w[1] to the product of the element d[n] and the element w[n], which enables detection of, for example, both an element d[i] and an element w[j] that contribute to the similarity S the most, contribute to the similarity S more, contribute to the similarity S less, or contribute to the similarity S the least.

### Second Embodiment

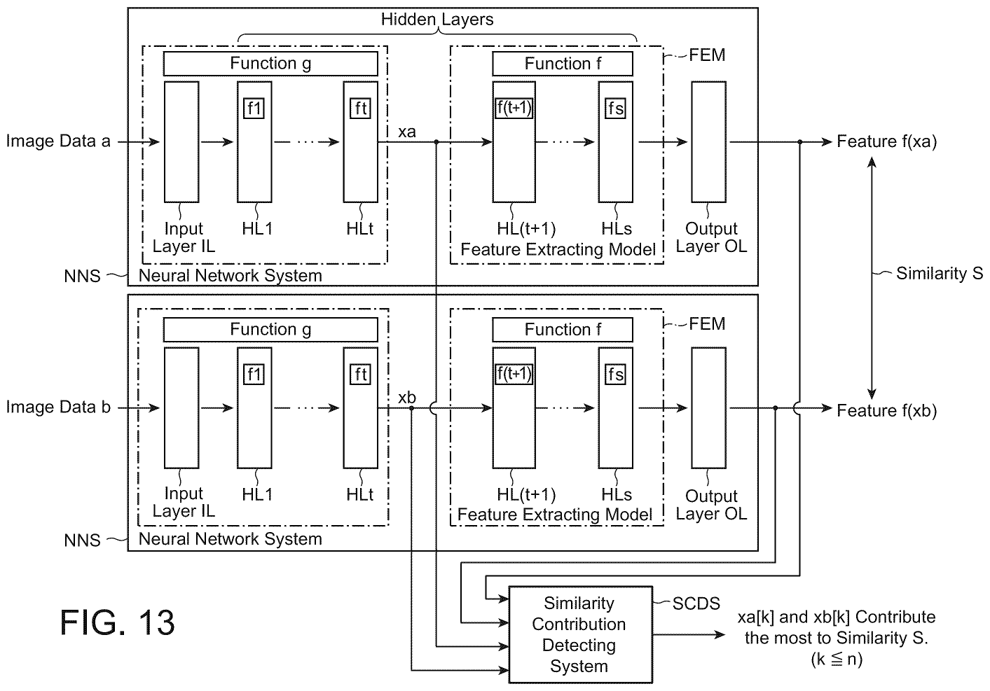

A similarity contribution detecting system according to a second embodiment of this disclosure will now be described with reference to FIGS. 13 to 15.

FIG. 13 is a block diagram showing a configuration of a neural network system NNS. Similar to the feature extracting system FES of the first embodiment (shown in FIG. 2, for example) the neural network system NNS of the second embodiment provides Feature f(a) in response to the image data a, and provides Feature f(b) in response to the image data b as shown in FIG. 13.

As shown in FIG. 13, the neural network system NNS includes, as well known, an input layer IL, a plurality of hidden layers (intermediate layers) HL1 to HLs, and an output layer OL, where s is a positive integer equal to or more than two.

The input layer IL receives the image data a and forwards the image data a to the hidden layer HL1. Similarly, the input layer IL receives the image data b and forwards the image data b to the hidden layer HL1.

The plurality of hidden layers HL1 to HLs have a plurality of functions f1 to fs, respectively. For example, the hidden layer HL1 has the function f1, and implements the function f1 on the image data a forwarded from the input layer IL1. Similar to the hidden layer HL1, the hidden layers HL2 to HL(s−1) (not shown in FIG. 13) implement the functions f2 to f (s−1) (not shown in FIG. 13) on data fed from a preceding hidden layer and provide results of the function f2 to f (s−1) to a following hidden layer. For example, the hidden layer HL2 implements the function f2 on f1 (a) fed from the hidden layer HL1 and provides a result f2 (f1 (a)) to the hidden layer HL3. Finally, the hidden layer HLs implements the function fs on data fed from the hidden layer HL (s−1) and provides a result of the function fs to the output layer OL.

The output layer receives the result of the function fs from the hidden layer HLs and provides the result of the function fs outside of the neural network system NNS.

Similar to the above, the neural network system NNS implements the functions f1 to fs on image data b as shown in FIG. 13.

Similar to the similarity contribution detecting system SCDS according to the first embodiment, a similarity contribution detecting system SCDS according to the second embodiment (shown in FIG. 9) receives the image data a, the image data b, Feature f(a), and Feature f(b) as shown in FIG. 13.

From the constructional viewpoint, the similarity contribution detecting system SCDS according to the second embodiment has the configuration similar to that of the similarity contribution detecting system SCDS according to the first embodiment shown in FIG. 10.

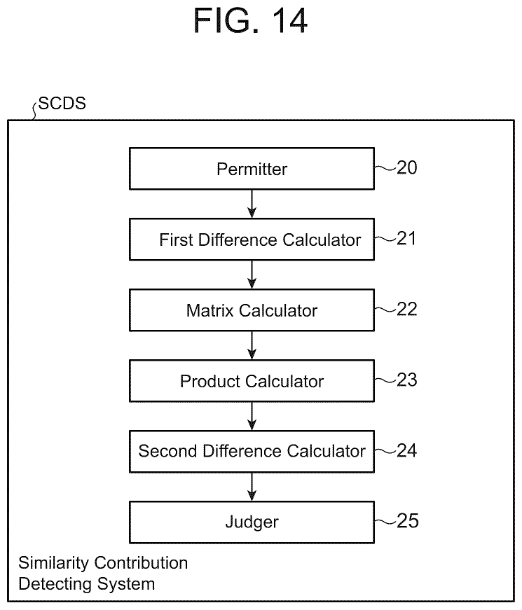

FIG. 14 is a block diagram showing a configuration of the similarity contribution detecting system SCDS according to the second embodiment from the functional viewpoint. Similar to the similarity contribution detecting system SCDS according to the first embodiment, the similarity contribution detecting system SCDS according to the second embodiment includes a first difference calculator 21, a matrix calculator 22, a product calculator 23, a second difference calculator 24, and a judger 25 as shown in FIG. 14. In addition thereto, the similarity contribution detecting system SCDS further includes a permitter 20.

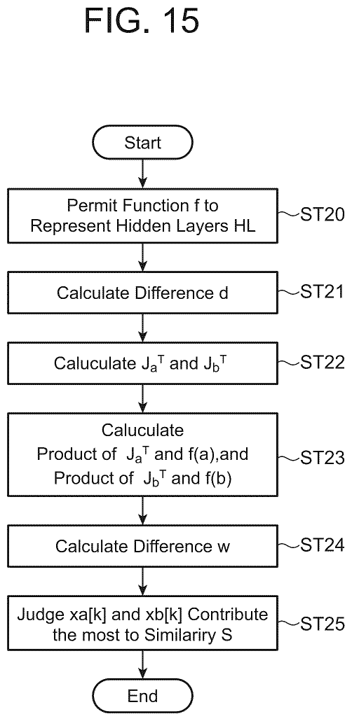

With reference to FIGS. 10 and 15, the input unit 1 and the output unit 3 serve as a user interface for a user manipulating the similarity contribution detecting system SCDS according to the second embodiment; the processor 2 acts as each of the permitter 20 to the judger 25 by executing in the memory 4 the program 6 stored in the storage 5.

FIG. 15 is a flowchart showing an operation of the similarity contribution detecting system SCDS according to the second embodiment.

Here, below is assumed.
(as-1) The neural network system NNS receives the image data a and b as shown in FIG. 13.
(as-2) The hidden layer HLt provides intermediate data xa deriving from the image data a, and provides intermediate data xb deriving from the image data b, where t is a positive integer less than or equal to s, and the intermediate data xa and xb have the configurations similar to those of the image data a and b shown in FIGS. 3 to 4.

At step ST20, the permitter 20 permits selects among all the hidden layers HL1 to HLs, some hidden layers HL, for example, the hidden layer HL (t+1) to the hidden layer HLs. Thus, the permitter 20 generates a feature extracting model FEM that is composed of the selected hidden layers HL (t+1) to HLs and is provided with function f, where the function f includes the functions f (t+1) to fs of the selected hidden layers HL (t+1) to HLs as shown in FIG. 13. In other words, the permitter 20 permits the function f of the feature extracting model FEM to represent all the function f (t+1) to fs of the selected hidden layers HL (t+1) to HLs.

At step ST21 similar to step ST11 in the first embodiment, the first difference calculator 21 calculates the difference d in conformity with Formula (1), and more specifically, generates the element d[j] between the element xb[j] and the element xa[j] in conformity with Formula (2).

At step ST22 similar to step ST12 in the first embodiment, the matrix calculator 22 calculates the transposed Jacobian matrix Ja^{T} (shown in FIG. 8) by partially differentiating the function f (shown in FIG. 13) with respect to the intermediate data xa to yield the Jacobian matrix Ja (shown in FIG. 5) and transposing the Jacobian matrix Ja. Similarly, the matrix calculator 22 calculates the transposed Jacobian matrix Jb^{T} (shown in FIG. 8) by partially differentiating the function f with respect to the intermediate data xb to yield the Jacobian matrix Jb (shown in FIG. 6) and transposing the Jacobian matrix Jb.

At step ST23 similar to step ST13 in the first embodiment, the product calculator 23 calculates the first product wa, that is, the variable wa (shown in FIG. 8) by using the transposed Jacobian matrix Ja^{T} and the intermediate data xa in conformity with Formula (3), and calculates the second product wb, that is, the variable wb (shown in FIG. 8) by using the transposed Jacobian matrix Jb^{T} and the intermediate data xb in conformity with Formula (4).

At step ST24 similar to step ST14 in the first embodiment, the second difference calculator 24 calculates the second difference w, that is, the difference w (shown in FIG. 8) pursuant to Formula (5) as shown in FIG. 8. More specifically, the second difference calculator 24 yields the element w[j] between the element wa[j] and the element wb[j] pursuant to Formula (6) as shown in FIG. 8.

At step ST25 similar to step ST15 in the first embodiment, the judger 25 judges that a larger product of the element d[j] and the element w[j] among all of a product of the element d[1] and the element w[1] to a product of the element d[n] and the element w[n] (implicitly shown in FIG. 8) contributes more to the similarity S between Feature f (xa) and Feature f (xb) (shown in FIG. 13). Among the elements xa[1] to xa[n] and the elements xb[1] to xb[n], the judger 25 judges, for example, that an element xa[k] and an element xb[k] contribute the most to the similarity S, where k is less than or equal to n.

In addition to the above, the judger 25 judges which of the following contributes more to the similarity S.
(1) the function f of the feature extracting system FES (the function f is composed of the functions f (t+1) to fs as explained above)
(2) a function g composed of the functions f1 to ft in the not selected hidden layers HL1 to HLt, that is, the remainder laid prior to the selected hidden layers HL (t+1) to HLs (the function g is represented by the intermediate data xa and xb)

If there is any rather larger product of an element xa[l] and an element xb[l], the judger 25 judges that the function f (the hidden layers HL (t+1) to HLs). may contribute to the similarity S less than the function g (the hidden layers HL1 to HLt), where l is less than or equal to n. To the contrary, if there is not any rather larger product of an element xa[l] and an element xb[l], the judger 25 judges that the function f may contribute to the similarity S more than the function g.

As described above, the similarity contribution detecting system SCDS according to the second embodiment analyzes or evaluates the intermediate data xa and xb fed into the feature extracting system FES in the neural network system NNS, and Feature f (xa) and Feature f (xb) provided therefrom, and more specifically analyzes or evaluates each of the product of the element d[1] and the element w[1] to the product of the element d[n] and the element w[n] similar to the similarity contribution detecting system SCDS according to the first embodiment. Similar to the first embodiment, this enables detection of, for example, both an element d[j] and an element w[j] that contribute to the similarity S the most, contribute to the similarity S more, contribute to the similarity S less, or contribute to the similarity S the least.

In addition to the effect above, the similarity contribution detecting system SCDS according to the second embodiment can judge which of the function f (the selected hidden layers HL (t+1) to HLs) and the function g (the not selected hidden layers HL1 to HLt) contribute more or less to the similarity S.

### Third Embodiment

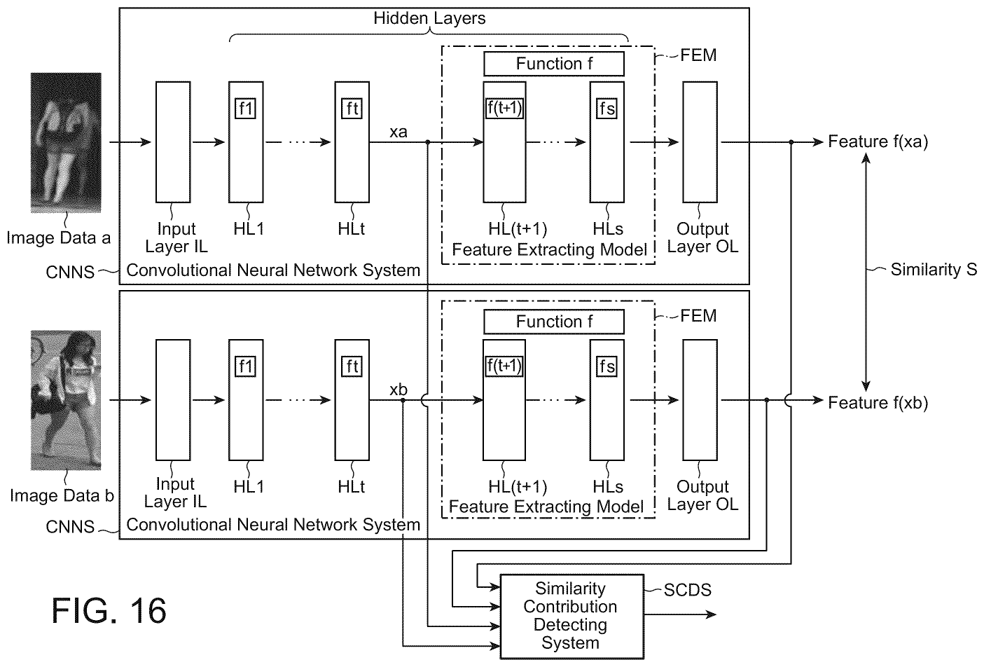

A similarity contribution detecting system according to a third embodiment will now be described with reference to FIGS. 16 to 22.

FIG. 16 is a block diagram showing a configuration of a convolutional neural network system CNNS. The convolutional neural network CNNS has, as well known, a convolution layer (not shown) and a pooling layer (not shown). To simplify blow explanation, the convolutional neural network CNNS is herein illustrated with a configuration similar to that of the neural network system NNS of the second embodiment. The convolutional neural network CNNS is, as well known, suitable for extracting a feature from image data, for example.

As shown in FIG. 16, similar to the second embodiment, the similarity contribution detecting system SCDS according to the third embodiment analyzes intermediate data xa and xb laid in the convolutional neural network system CNNS, and Feature f (xa) and Feature f (xb) provided therefrom, where the intermediate data xa and xb, and Feature f (xa) and Feature f (xb) derive from image data a and b fed thereinto.

From the constructional viewpoint, the similarity contribution detecting system SCDS according to the third embodiment has the configuration similar to that of the similarity contribution detecting system SCDS according to the first embodiment shown in FIG. 10.

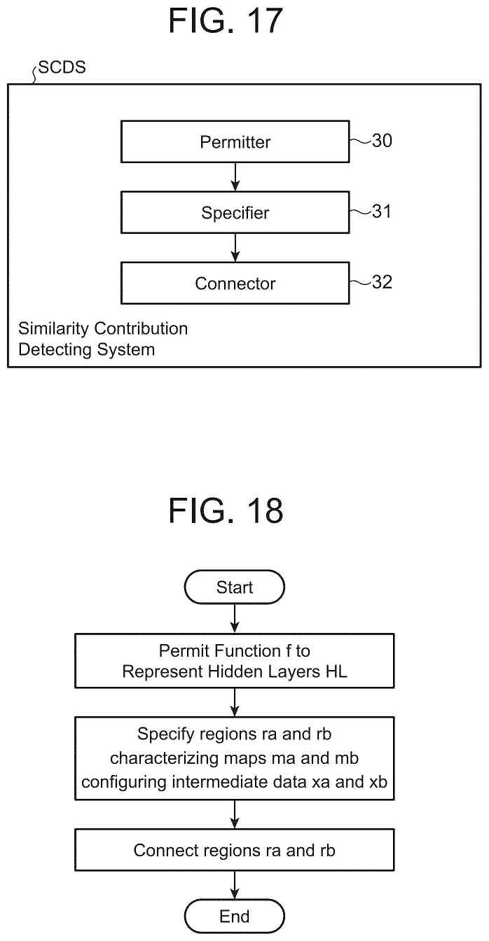

FIG. 17 is a block diagram showing a configuration of the similarity contribution detecting system SCDS according to the third embodiment from the functional viewpoint. The similarity contribution detecting system SCDS according to the third embodiment includes a permitter 30, a specifier 31, and a connector 32 as shown in FIG. 17.

With reference to FIGS. 10 and 17, the input unit 1 and the output unit 3 serve as a user interface for a user manipulating the similarity contribution detecting system SCDS according to the third embodiment; the processor 2 acts as each of the permitter 30, a specifier 31, and the connector 32 by executing in the memory 4 the program 6 stored in the storage 5.

FIG. 18 is a flowchart showing an operation of the similarity contribution detecting system SCDS according to the third embodiment.

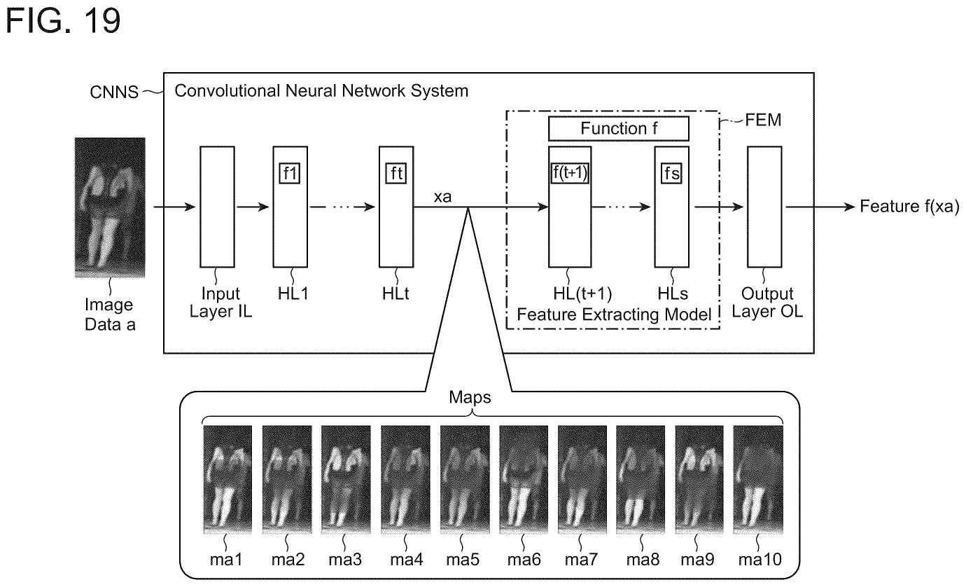

FIG. 19 is a block diagram showing an operation of the convolutional neural network system CNNS on the image data a.

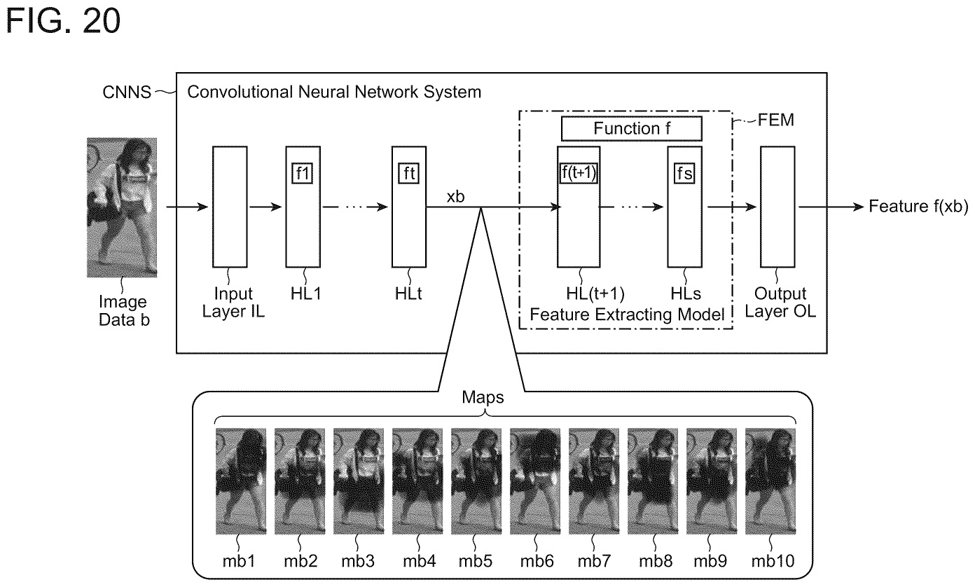

FIG. 20 is a block diagram showing an operation of the convolutional neural network system CNNS on the image data b.

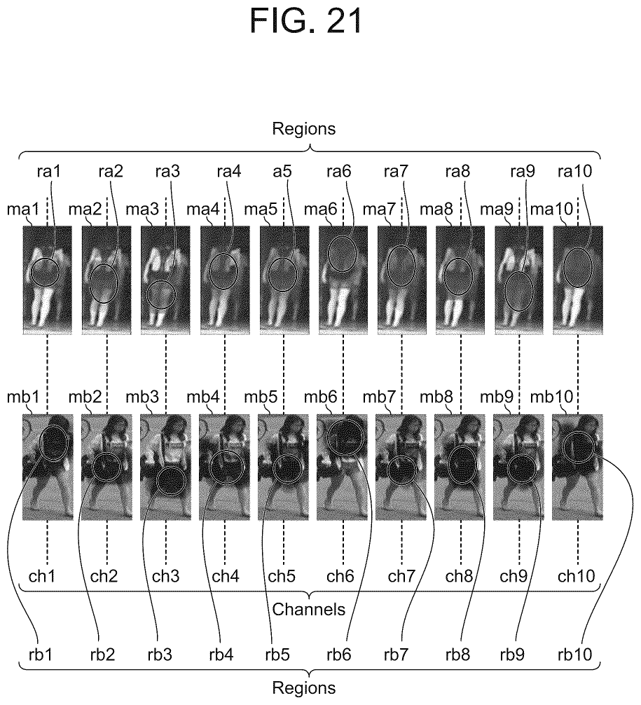

FIG. 21 shows a relationship among a plurality of maps ma and mb, a plurality of regions ra and rb, and a plurality of channels ch.

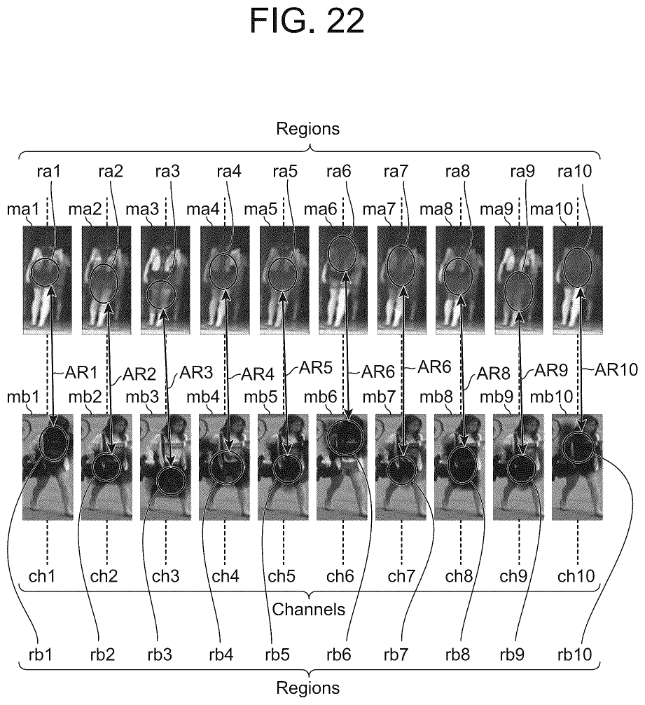

FIG. 22 shows connections between the plurality of regions ra and the plurality of regions rb.

For ease of explaining and understanding, the assumptions (as-1) and (as-2) in the second embodiment, which are introduced above in the second embodiment, are also applied to the third embodiment.

In addition to the assumptions (as-1) and (as-2) above, below are assumed.
(as-3) The intermediate data xa is composed of a plurality of maps, so-called feature maps ma1 to ma10 (shown in FIG. 19) corresponding to a plurality of channels ch1 to ch10 (shown in FIG. 21). For example, the map ma1 is corresponding to the channel ch1 while the map ma10 is corresponding to the channel ch10.
(as-4) Similar to the above, the intermediate data xb is composed of a plurality of maps mb1 to mb10 (shown in FIG. 20) corresponding to a plurality of channels ch1 to ch10 (shown in FIG. 21). For example, the map mb1 is corresponding to the channel ch1 while the map mb10 is corresponding to the channel ch10.

At step ST30 similar to step 20 in the second embodiment, the permitter 30 permits the function f of the feature extracting model FEM to represent the functions f (t+1) to fs of the selected hidden layers HL (t+1) to HLs as shown in FIG. 19.

At step ST31, the specifier 31 specifies the plurality of regions ra1 to ra10 that respectively characterizes the plurality of maps ma1 to ma10 by filtering the plurality of maps ma1 to ma10 as shown in FIG. 21. For example, the specifier 31 specifies the region ra1 that characterizes the map ma1 by filtering the map ma1 and specifies the region ra10 that characterizes the map ma10 by filtering the map ma10.

Similar to the above, the specifier 31 specifies the plurality of regions rb1 to rb10 that respectively characterizes the plurality of maps mb1 to mb10 by filtering the plurality of maps mb1 to mb10 as shown in FIG. 21. For example, the specifier 31 specifies the region rb1 that characterizes the map mb1 by filtering the map mb1 and specifies the region rb10 that characterizes the map mb10 by filtering the map mb 10.

At step ST32, the connector 32 connects the plurality of regions ra and the plurality of regions rb for each of the plurality of channels ch1 to ch10 as shown in FIG. 22. For example, the connector 32 connects the regions ra1 and the regions rb1 each other for the channel ch1, and connects the region ra10 and the region rb10 each other for the channel ch10.

As described above, the similarity contribution detecting system SCDS according to the third embodiment can visualize the relationship between the plurality of regions ra and the plurality of regions rb that characterize the intermediate data xa and xb.

### Fourth Embodiment

In general, the Jacobian matrices Ja and Jb explained above are too large to handle readily. Accordingly, a fourth embodiment of this disclosure will now discuss a method of calculating, for example, Ja^{T}f(a) by not calculating the Jacobian matrix Ja.

A backward propagation, which is well-known in the machine learning models, enables calculating a derivative dL/dy from a scalar function L (y), where L denotes a loss, which is also well-known in the machine learning models.

Defining a scalar function L(f (x)) by using Feature f (x) explained above gives Formula (20) through so-called chain rule.

$$dL ( f ( x ) ) / dx = {J}_{x}^{T} dL / df \qquad ( 20 )$$

Defining Formula (21) leads Formula (22) through Formula (23).

$$L ( y ) = \frac{1}{2} {sum}_{i = 1 … n} {y [ i ]}^{2} \qquad ( 21 )$$

$$dL ( y ) / dy = y \qquad ( 22 )$$

$$dL ( y ) / dy [ i ] = y [ i ] ( for i = 1 … n ) \qquad ( 23 )$$

Substituting Feature f (x=a) for the scalar function L and applying the backward propagation above brings Formula (24).

$$dL ( y = f ( x = a ) ) / dx \qquad ( 24 )$$

$$= \begin{matrix}{( df / {dxl}_{x = a} )}^{T} & dL / {dyl}_{y = f ( x = a )}\end{matrix}$$

$$= {J}_{a}^{T} dL / {dyl}_{y = f ( x = a )}$$

$$= {J}_{a}^{T} {yl}_{y = f ( x = a )}$$

$$= {J}_{a}^{T} f ( x = a )$$

Similar to the above, Jb^{T}f(b) is calculated by not calculating the Jacobian matrix Jb.

1. A method of comprising:
calculating a first difference d between first input data a and second input data b that are provided to a machine learning model that has a function f and outputs a first result f(a) and a second result f(b) in response to the first input data a and the second input data b respectively, where d=(elements d[1], d[2], . . . , d[n]), a=(elements a[1], a[2], . . . , a[n]), b=(elements b[1], b[2], . . . , b[n]), f(a)=(f(a)[1], f(a)[2], . . . , f(a)[m]), f(b)=(f(b)[1], f(b)[2], . . . , f(b)[m]), and n and m are positive integers;
calculating a transposed Jacobian matrix Ja^{T} and a transposed Jacobian matrix Jb^{T} by partially differentiating the function f with respect to the first input data a and the second input data b to yield a Jacobian matrix Ja and a Jacobian matrix Jb, and transposing the Jacobian matrix Ja and the Jacobian matrix Jb;
calculating a first product of the transposed Jacobian matrix Ja^{T} and the result f(a), and a second product of the transposed Jacobian matrix Jb^{T} and the result f(b);
calculating a second difference w between the first product and the second product, where w=(elements w[1], w[2], . . . , w[n]); and
judging that a larger product of an element d[j] of the first difference d and an element w[j] of the second difference w contributes more to a similarity between the first result f(a) and the second result f(b), where j is a positive integer less than or equal to n.

2. The method according to claim 1, further comprising:
in a case where the machine learning model is a neural network that includes a plurality of intermediate layers,
permitting the function f to represent at least one of the plurality of intermediate layers; and
judging that the function f contributes to the similarity less than a function g that represents a remainder of the plurality of intermediate layers prior to the at least one of the plurality of intermediate layers when a product of an element d[j] of the first difference d and an element w[j] of the second difference w, the first difference d and the second difference w being defined by using first intermediate data xa and second intermediate data xb fed into the function f, and a first result f(xa) and a second result f(xb) output by the function f, in lieu of using the first input data a and the second input data b, and the first result f(a) and the second result f(b).

3. The method according to claim 1, further comprising:
in a case where the machine learning model is a convolutional neural network that includes a plurality of intermediate layers,
permitting the function f to represent at least one of the plurality of intermediate layers; and
specifying a first plurality of regions ra that respectively characterize a first plurality of maps ma that configure first intermediate data xa and a second plurality of regions rb that respectively characterize a second plurality of maps mb that configure second intermediate data xb, by filtering the first plurality of maps ma and the second plurality of maps mb respectively; the first intermediate data xa and the second intermediate data xb being output by a function g that represent a remainder of the plurality of intermediate layers prior to the at least one of the plurality of intermediate layers in response to the input data a and the second input data b respectively and fed into the function f and;
connecting the first plurality of regions ra to the second plurality of regions rb for each of a plurality of channels that correspond to the first plurality of maps ma and the second plurality of maps mb.

4. The method according to claim 1, further comprising:
defining a first scalar function L(f(a)) by using the first result f(a), where L(x) is a sum of squared x[i] and x=(elements x[1], x[2], . . . , x[n]);
defining a second scalar function L(f(b)) by using the second result f(b);
calculating a first derivative dL(f(a))/dx of the first scalar function L(f(a)) by using a backward propagation in the machine learning model; and
calculating a second derivative dL(f(b))/dx of the second scalar function L(f(b)) by using the backward propagation.

5. A system comprising:
a processor to execute a program; and
a memory to store the program which, when executed by the processor, performs processes of, calculating a first difference d between first input data a and second input data b that are provided to a machine learning model that has a function f and outputs a first result f(a) and a second result f(b) in response to the first input data a and the second input data b respectively, where d=(elements d[1], d[2], . . . , d[n]), a=(elements a[1], a[2], . . . , a[n]), b=(elements b[1], b[2], . . . , b[n]), f(a)=(f(a)[1], f(a)[2], . . . , f(a)[m]), f(b)=(f(b)[1], f(b)[2], . . . , f(b)[m]), and n and m are positive integers;
calculating a transposed Jacobian matrix Ja^{T} and a transposed Jacobian matrix Jb^{T} by partially differentiating the function f with respect to the first input data a and the second input data b to yield a Jacobian matrix Ja and a Jacobian matrix Jb, and transposing the Jacobian matrix Ja and the Jacobian matrix Jb;
calculating a first product of the transposed Jacobian matrix Ja^{T} and the result f(a), and a second product of the transposed Jacobian matrix Jb^{T} and the result f(b);
calculating a second difference w between the first product and the second product, where w=(elements w[1], w[2], . . . , w[n]); and
judging that a larger product of an element d[j] of the first difference d and an element w[j] of the second difference w contributes more to a similarity between the first result f(a) and the second result f(b), where j is a positive integer less than or equal to n.
